(19) United States
(12) Patent Application Publication
(10) Pub. No.: US 2023/0142215 A1
(43) Pub. Date: May 11, 2023

(54) WLAN on 60GHz Frequency Bands

(71) Applicant: Meta Platforms, Inc., Menlo Park, CA (US)

(72) Inventors: Krishna Srikanth Gomadam, San Jose, CA (US); Djordje Tujkovic, Los Altos, CA (US)

(21) Appl. No.: 18/051,392

(22) Filed: Oct. 31, 2022

Related U.S. Application Data
(60) Provisional application No. 63/276,114, filed on Nov. 5, 2021.

(51) Int. Cl. H04L 5/00; H04W 72/04

(52) U.S. Cl. CPC H04L 5/0007; H04W 72/0453; H04W 84/12

(57) ABSTRACT

In one embodiment, a method includes receiving intermediate frequency (IF) signals for k spatial layers to be transmitted from a wireless modem associated with the wireless communication device, where each of the k spatial layers occupies a pre-determined bandwidth, and where k is two or more, converting the IF signals into radio frequency (RF) signals by converting each of the k spatial layers into each of k orthogonal channel bands, where neighboring two channel bands among the k orthogonal channel bands are separated by a pre-determined frequency separation that is large enough to avoid interference between the two channel bands, and sending the RF signals to a radio-frequency integrated circuit (RFIC) associated with the wireless communication device, where the RFIC transmits the RF signals wirelessly.

### PRIORITY

This application claims the benefit under 35 U.S.C. § 119(e) of U.S. Provisional Patent Application No. 63/276114, filed 5 Nov. 2021, which is incorporated herein by reference.

### TECHNICAL FIELD

This disclosure generally relates to wireless networks, and in particular relates to enabling Wireless Local Area Networks (WLANs) in 60 GHz frequency bands.

### BACKGROUND

WLANs based on Institute of Electrical and Electronics Engineers (IEEE) 802.11 have been widely used over the last several decades. IEEE 802.11ax, officially marketed by the Wi-Fi Alliance as Wi-Fi 6 (2.4 GHz and 5 GHz) and Wi-Fi 6E (6 GHz), became an IEEE standard for WLANs in September 2020. IEEE 802.11ax is designed to operate in license-exempt bands between 1 and 7.125 GHz, including the already commonly used 2.4 and 5 GHz bands as well as the much wider 6 GHz band (5.925-7.125 GHz in the US). The main goal of IEEE 802.11ax is enhancing throughput-per-area in high-density scenarios, such as corporate offices, shopping malls and dense residential apartments. While the nominal data rate improvement against 802.11ac is only 37%, the overall throughput increase (over an entire network) is 300%.

IEEE 802.11be is a potential next amendment of the 802.11 IEEE standard, which may be designated Wi-Fi 7. IEEE 802.11be may build upon 802.11ax, focusing on WLAN indoor and outdoor operation with stationary and pedestrian speeds in the 2.4, 5, and 6 GHz frequency bands. Speeds are expected to reach 40 Gbps.

Multi-User Multiple-Input Multiple-Output (MIMO) was introduced in 802.11ac (a predecessor of 802.11ax), which is a spatial multiplexing technique. MU-MIMO allows the access point to form beams towards each client, while transmitting information simultaneously. By doing so, the interference between clients is reduced, and the overall throughput is increased, since multiple clients can receive data simultaneously.

60 GHz bands have been considered for WLANs because of potentially much faster data transmissions. IEEE 802.11ad and IEEE 802.11ay have been developed for 60 GHz WLANs. However, 60 GHz WLANs have not gained popularity. Thus, commercial products for 60 GHz WLANs have not introduced in the markets.

### SUMMARY OF PARTICULAR EMBODIMENTS

Particular embodiments described herein relate to systems and methods for enabling WLANs in 60 GHz frequency bands by reusing commercially available chipsets. While 60 GHz frequency bands may allow significantly higher data rates with larger bandwidth and lower interferences, no commercial 60 GHz WLAN chipset is available. WLAN modem chipsets have been evolving into IEEE 802.11ax and IEEE 802.11be chipsets. Therefore, a number of WLAN modem chipsets supporting IEEE 802.11ax and/or IEEE 802.11be are available. Also, a number of Radio Frequency Integrated Circuit (RFIC) for 60 GHz bands are available. The embodiments disclosed herein may enable WLANs in 60 GHz frequency bands using one of those WLAN modem chipsets along with the 60 GHz RFIC available in the market. As 60 GHz frequencies do not support Multiple-Input Multiple-Output (MIMO) due to the wireless channel characteristics, the spatial layers from WLAN modem chipsets may need to be converted into a number of orthogonal channel bands in 60 GHz frequencies to increase the throughput. The embodiments disclosed herein may introduce a module that converts k spatial layers into converted signals of k orthogonal frequency bands, and vice versa.

In particular embodiments, a module of a first wireless communication device may receive intermediate frequency (IF) signals for k spatial layers to be transmitted from a wireless modem associated with the first wireless communication device, where k is two or more. Each of the k spatial layers may occupy a pre-determined bandwidth. In particular embodiments, the wireless modem may be a baseband modem. In such a case, the IF signals may be analog in-phase and quadrature (I/Q) signals. In particular embodiments, the wireless modem may be a system on a chip (SoC) comprising a baseband module and an RF module. In such a case, the IF signals are generated by the RF module within the wireless modem. The module may convert the IF signals into radio frequency (RF) signals by converting each of the k spatial layers into each of k orthogonal channel bands. Neighboring two channel bands among the k orthogonal channel bands may be separated by a pre-determined frequency separation that is large enough to avoid interference between the two channel bands. The RF signals may be 60 GHz signals. The module may send the RF signals to a radio-frequency integrated circuit (RFIC) associated with the first wireless communication device. The RFIC may transmit the RF signals wirelessly. The RFIC may be a 60 GHz RFIC. In particular embodiments, the module may be a part of the wireless modem. In particular embodiments, the module may be a part of the RFIC. In particular embodiments, the module may be on a printed circuit board (PCB). The wireless modem may send control parameters to the RFIC through a control interface. The control interface may be provided with general-purpose input/output (GPIO) pins. The control parameters may comprise a transmit and receive beam index, a transmit power, or a receive gain index.

In particular embodiments, the module of the first wireless communication device may receive RF signals from an RFIC. The RF signals may be received from a second wireless communication device. The RF signals may comprise k orthogonal channel bands. The module may convert the RF signals into IF signals by converting signals from each of the k orthogonal channel bands into each of k spatial layers. The module may send the IF signals to the wireless modem. The wireless modem may decode the data from each of the k spatial layers.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example logical architecture of a wireless communication device that enables WLANs in 60 GHz frequency bands by reusing commercially available chipsets.

FIG. 2 illustrates an example IF/RF converter module that convert a number of spatial layers into the number of orthogonal channels bands.

FIG. 3 illustrates an example control interface of a wireless communication device that enables WLANs in 60 GHz frequency bands by reusing commercially available chipsets.

FIG. 4 illustrates an example wireless data transmission from a first wireless communication device to a second wireless communication device.

FIG. 5 illustrates an example method 500 for converting IF signals to RF signals for transmitting signals over a WLAN in 60 GHz frequency bands by reusing commercially available chipsets.

FIG. 6 illustrates an example method $00 for converting RF signals to IF signals for receiving signals over a WLAN in 60 GHz frequency bands by reusing commercially available chipsets.

FIG. 7 illustrates an example computer system.

### DESCRIPTION OF EXAMPLE EMBODIMENTS

In particular embodiments, a module of a wireless communication device may enable WLANs in 60 GHz frequency bands by reusing commercially available chipsets. While 60 GHz frequency bands may allow significantly higher data rates with larger bandwidth and lower interferences, no commercial 60 GHz WLAN chipset is available. WLAN modem chipsets have been evolving into IEEE 802.11ax and IEEE 802.11be chipsets. Therefore, a number of WLAN modem chipsets supporting IEEE 802.11ax and/or IEEE 802.11be are available. Also, a number of Radio Frequency Integrated Circuit (RFIC) for 60 GHz bands are available. The embodiments disclosed herein may enable WLANs in 60 GHz frequency bands using one of those WLAN modem chipsets along with the 60 GHz RFIC available in the market. As 60 GHz frequencies do not support Multiple-Input Multiple-Output (MIMO) due to the wireless channel characteristics, the spatial layers from WLAN modem chipsets may need to be converted into a number of orthogonal channel bands in 60 GHz frequencies to increase the throughput. The embodiments disclosed herein may introduce a module that converts k spatial layers into converted signals of k orthogonal frequency bands, and vice versa.

In particular embodiments, a module of a first wireless communication device may receive intermediate frequency (IF) signals for k spatial layers to be transmitted from a wireless modem associated with the first wireless communication device, wherein k is two or more. Each of the k spatial layers may occupy a pre-determined bandwidth. In particular embodiments, the wireless modem may be a baseband modem. In such a case, the IF signals may be analog in-phase and quadrature (I/Q) signals. In particular embodiments, the wireless modem may be a system on a chip (SoC) comprising a baseband module and an RF module. In such a case, the IF signals are generated by the RF module within the wireless modem. The module may convert the IF signals into radio frequency (RF) signals by converting each of the k spatial layers into each of k orthogonal channel bands. Neighboring two channel bands among the k orthogonal channel bands may be separated by a pre-determined frequency separation that is large enough to avoid interference between the two channel bands. The RF signals may be 60 GHz signals. The module may send the RF signals to a radio-frequency integrated circuit (RFIC) associated with the first wireless communication device. The RFIC may transmit the RF signals wirelessly. The RFIC may be a 60 GHz RFIC. In particular embodiments, the module may be a part of the wireless modem. In particular embodiments, the module may be a part of the RFIC. In particular embodiments, the module may be on a printed circuit board (PCB). The wireless modem may send control parameters to the RFIC through a control interface. The control interface may be provided with general-purpose input/output (GPIO) pins. The control parameters may comprise a transmit and receive beam index, a transmit power, or a receive gain index.

The module of the first wireless communication device may receive RF signals from an RFIC. The RF signals may be received from a second wireless communication device. The RF signals may comprise k orthogonal channel bands. The module may convert the RF signals into IF signals by converting signals from each of the k orthogonal channel bands into each of k spatial layers. The module may send the IF signals to the wireless modem. The wireless modem may decode the data from each of the k spatial layers.

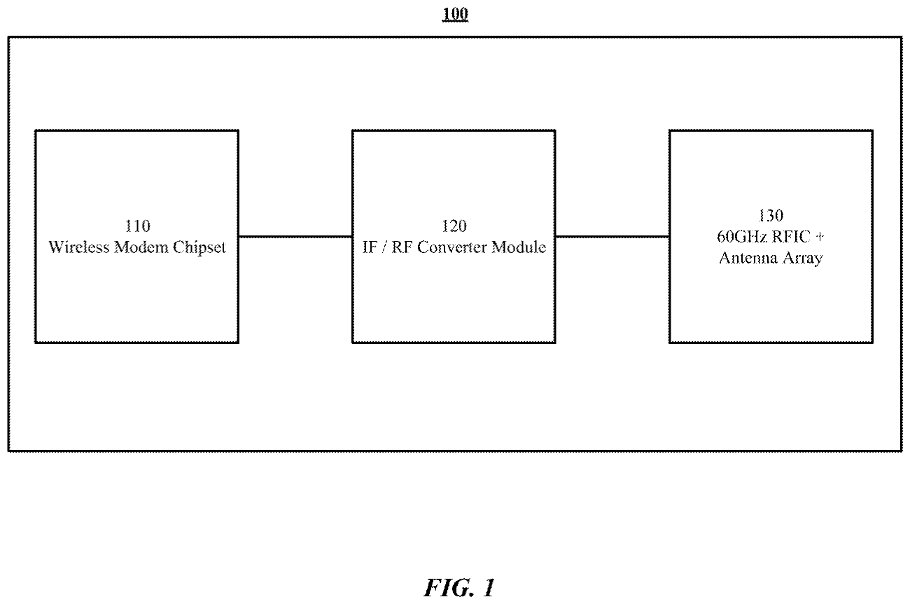

FIG. 1 illustrates an example logical architecture of a wireless communication device that enables WLANs in 60 GHz frequency bands by reusing commercially available chipsets. The wireless communication device 100 may comprise a wireless modem chipset 110, an IF/RF converter module 120, and a 60 GHz RFIC along with an antenna array. The wireless modem chipset 110 may be an over the counter 802.11ax capable chipset or an 802.11be chipset. The 60 GHz RFIC 130 may also be a commercially available RFIC. The IF/RF converter module 120 may be a firmware module implemented on the wireless modem chipset 110. In particular embodiments, the IF/RF converter module 120 may be a firmware module implemented on the 60 GHz RFIC 130. In particular embodiments, the IF/RF converter module 120 may be on a printed circuit board (PCB) apart from the wireless modem chipset 110 or the 60 GHz RFIC 130. Although this disclosure describes a particular logical architecture of a wireless communication device, this disclosure contemplates any suitable logical architecture of a wireless communication device.

A module of a first wireless communication device may receive intermediate frequency (IF) signals for k spatial layers to be transmitted from a wireless modem associated with the first wireless communication device. k is two or more. Each of the k spatial layers may occupy a pre-determined bandwidth. As an example and not by way of limitation, the IF/RF converter module 120 may receive signals from the wireless modem chipset 110. As IEEE 802.11ax or IEEE 802.11be support MIMO, the signals from the wireless modem chipset 110, which is to be transmitted, may comprise a plurality of spatial layers. IEEE 802.11ax may support 8 spatial layers. Each of the 8 spatial layers may operate at a 160 MHz bandwidth. IEEE 802.11be may support 16 spatial layers. Each of the 16 spatial layers may operate at a 320 MHz bandwidth. Although this disclosure describes receiving IF signals for k spatial layers in a particular manner, this disclosure contemplates receiving IF signals for k spatial layers in any suitable manner.

In particular embodiments, the wireless modem may select between 5 GHz frequency and 60 GHz frequency for transmitting the signals based on conditions. In particular embodiments, the module may select between 5 GHz frequency and 60 GHz frequency for transmitting the signals based on conditions.

In particular embodiments, the wireless modem may be a baseband modem. In such a case, the IF signals may be analog in-phase and quadrature (UQ) signals. As an example and not by way of limitation, the wireless modem chipset 110 may comprise baseband modem. The IF/RF converter module 120 may receive analog I/Q signals as the IF signals. Although this disclosure describes the wireless modem being a baseband modem in a particular manner, this disclosure contemplates the wireless modem being a baseband modem in any suitable manner.

In particular embodiments, the wireless modem may be a system on a chip (SoC) comprising a baseband module and an RF module. In such a case, the IF signals are generated by the RF module within the wireless modem. As an example and not by way of limitation, the wireless modem chipset 110 may be a SoC with both baseband and RF. The RF may generate RF signals. For example, an IEEE 802.11ax RF may generate 6 GHz signals. The IF/RF converter module 120 may take the 6 GHz signals from the RF of the IEEE 802.11ax modem as IF signals. Although this disclosure describes wireless modem being a SoC comprising both baseband and RF in a particular manner, this disclosure contemplates wireless modem being a SoC comprising both baseband and RF in any suitable manner.

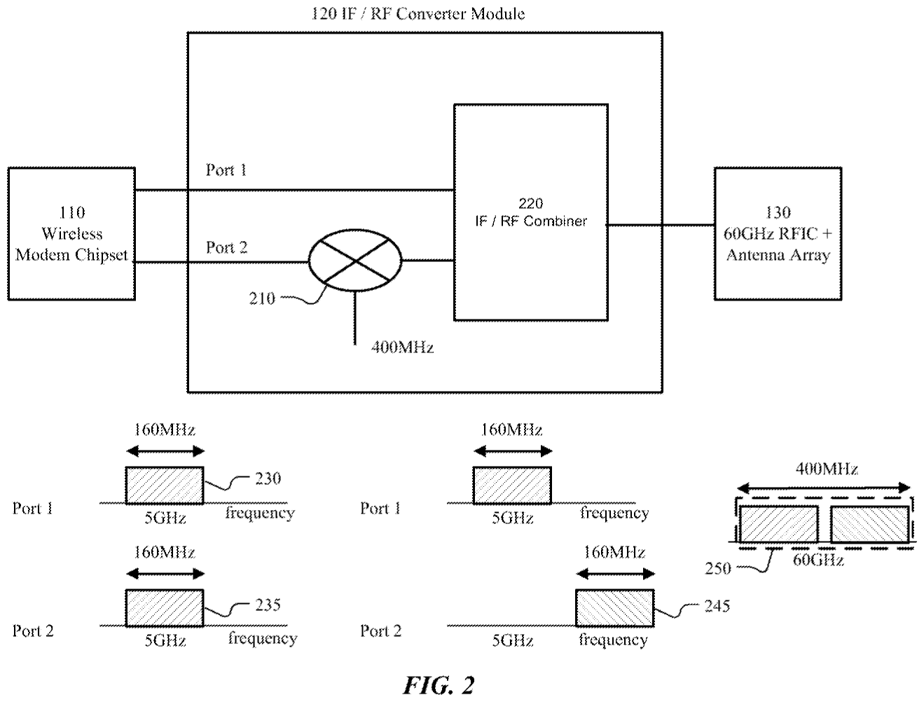

The module may convert the IF signals into radio frequency (RF) signals by converting each of the k spatial layers into each of k orthogonal channel bands. Neighboring two channel bands among the k orthogonal channel bands may be separated by a pre-determined frequency separation that is large enough to avoid interference between the two channel bands. The RF signals may be 60 GHz signals. FIG. 2 illustrates an example IF/RF converter module that convert a number of spatial layers into the number of orthogonal channels bands. In the example illustrated in FIG. 2, the wireless modem chipset 110 is IEEE 802.11ax chipset. Though the figure shows only two spatial layers for a simplicity purpose, the wireless modem chipset 110 may send up to 8 spatial layers. A first spatial layer 230 and a second spatial layer 235 are output of the RF of IEEE 802.11ax. Thus, the first spatial layer 230 and the second spatial layer 235 are on 5 GHz frequency bands. Each spatial layer is on a 160 MHz bandwidth. Upon receiving a first spatial layer 230 and a second spatial layer 235 from the wireless modem chipset 110, the IF/RF converter module 120 may shift the second spatial layer 235 using a frequency mixer 210 to a shifted signals 245 of the second spatial layer. If more spatial layers are received from the wireless modem chipset 110, the IF/RF converter module 120 may shift each spatial layer into a different channel band, orthogonal from each other, using the frequency mixer 210. The IF/RF converter module 120 may combine the first spatial layer 230 and the shifted signals 245 of the second spatial layer using an IF/RF combiner 220. The output of the IF/RF converter module may be combined signals 250 on 60 GHz bands. The total bandwidth for the combined signals may be 400 MHz as the channel bands corresponding to the spatial layers are separated enough to avoid interference. Although this disclosure describes converting a number of spatial layers into the number of orthogonal channel bands in a particular manner, this disclosure contemplates converting a number of spatial layers into the number of orthogonal channel bands in any suitable manner.

In particular embodiments, the module may perform a carrier frequency offset correction and a sampling offset correction per spatial layer.

The module may send the RF signals to a radio-frequency integrated circuit (RFIC) associated with the first wireless communication device. The RFIC may transmit the RF signals wirelessly. The RFIC may be a 60 GHz RFIC. As an example and not by way of limitation, continuing with a prior example illustrated in FIG. 2, the IF/RF converter module 120 may send the combined signals 250 to the 60 GHz RFIC 130. The 60 GHz RFIC 130 may transmit the combined signals 250 wirelessly using an antenna array associated with the 60 GHz RFIC 130. Although this disclosure describes transmitting the RF signals wirelessly in a particular manner, this disclosure contemplates transmitting the RF signals wirelessly in any suitable manner.

In particular embodiments, the module may be a part of the wireless modem. As an example and not by way of limitation, the IF/RF converter module 120 may be implemented in a firmware of the wireless modem chipset 110. A number of spatial layers that the wireless modem chipset 110 generates may be converted into combined signals of the number of orthogonal channel bands corresponding to the number of spatial layers. The combined signals may be sent to the 60 GHz RFIC 130. Although this disclosure describes implementing the IF/RF converter module as a part of the wireless modem in a particular manner, this disclosure contemplates implementing the IF/RF converter module as a part of the wireless modem in any suitable manner.

In particular embodiments, the module may be a part of the RFIC. As an example and not by way of limitation, the IF/RF converter module 120 may be implemented in a firmware of the 60 GHz RFIC 130. A number of spatial layers that the wireless modem chipset 110 generates may be sent to the 60 GHz RFIC 130. The IF/RF converter module 120 within the 60 GHz RFIC may convert the signals corresponding to the number of spatial layers into combined signals of the number of orthogonal channel bands corresponding to the number of spatial layers. The combined signals may be transmitted wireles sly by the 60 GHz RFIC 130. Although this disclosure describes implementing the IF/RF converter module as a part of the 60 GHz RFIC in a particular manner, this disclosure contemplates implementing the IF/RF converter module as a part of the 60 GHz RFIC in any suitable manner.

In particular embodiments, the module may exist separate from both the wireless modem and the RFIC. In particular embodiments, the module may be on a printed circuit board (PCB). As an example and not by way of limitation, the IF/RF converter module 120 may be deployed on a PCB. The wireless communication device may comprise a wireless modem 110, a separate PCB comprising the IF/RF converter module 120, and a 60 GHz RFIC. A number of spatial layers that the wireless modem chipset 110 generates may be sent to the IF/RF converter module 120 on the PCB. The IF/RF converter module 120 may convert the signals corresponding to the number of spatial layers into combined signals of the number of orthogonal channel bands corresponding to the number of spatial layers. The combined signals may be sent to the 60 GHz RFIC 130. The 60 GHz RFIC may transmit the combined signals wirelessly using an atenna array associated with the 60 GHz RFIC 130. Although this disclosure describes implementing the IF/RF converter module separate from the wireless modem and the RFIC in a particular manner, this disclosure contemplates implementing the IF/RF converter module separate from the wireless modem and the RFIC in any suitable manner.

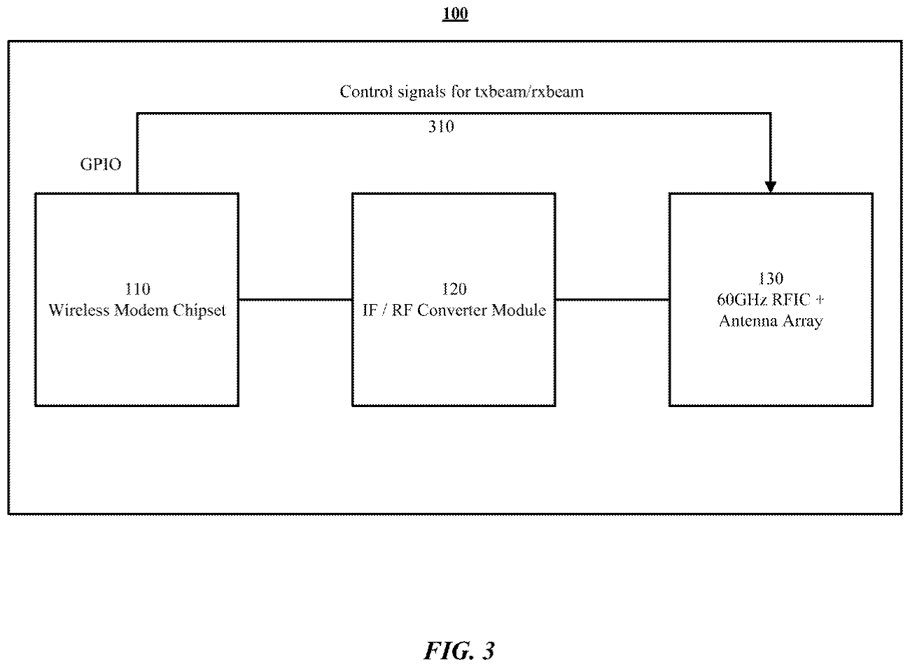

The wireless modem may send control parameters to the RFIC through a control interface. The control interface may be provided with general-purpose input/output (GPIO) pins. The control parameters may comprise a transmit and a receive beam index, a transmit power, or a receive gain index. The control parameters may need to be updated to the packet boundary. FIG. 3 illustrates an example control interface of a wireless communication device that enables WLANs in 60 GHz frequency bands by reusing commercially available chipsets. As an example and not by way of limitation, the wireless modem chipset 110 may send control parameters to the 60 GHz RFIC 130 with GPIO pins. Meanings of the control signals through GPIO pins may be pre-defined. The control parameters may be a transmit beam index, a receive beam index, a transmit power, and a receive gain index. Although this disclosure describes a particular control interface between the wireless modem and the RFIC, this disclosure contemplates any suitable control interface between the wireless modem and the RFIC.

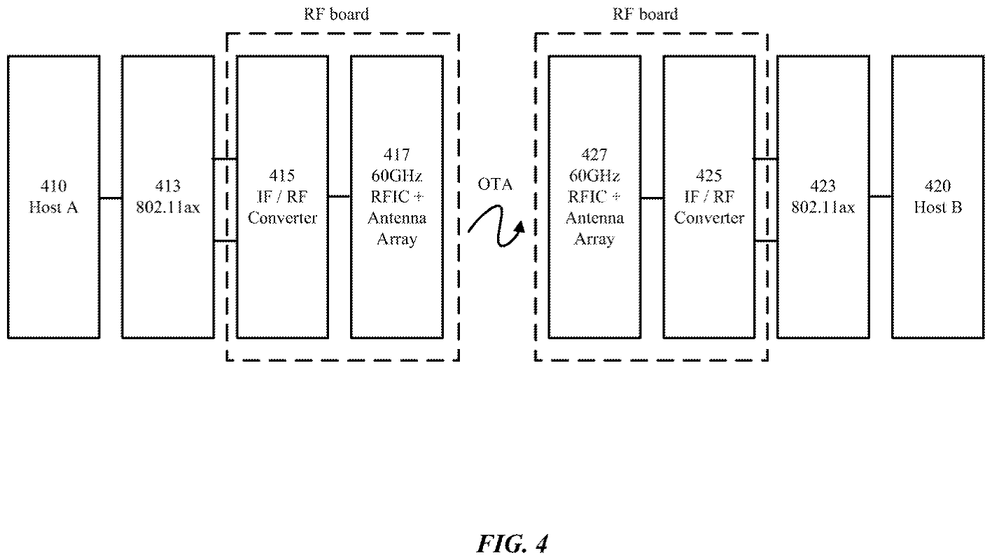

In particular embodiments, the module of the first wireless communication device may receive RF signals from an RFIC. The RF signals may be received from a second wireless communication device. The RF signals may comprise k orthogonal channel bands. The module may convert the RF signals into IF signals by converting signals from each of the k orthogonal channel bands into each of k spatial layers. The module may send the IF signals to the wireless modem. The wireless modem may decode the data from each of the k spatial layers. FIG. 4 illustrates an example wireless data transmission from a first wireless communication device to a second wireless communication device. As an example and not by way of limitation, an application of host A 410 may need to transmit a message to an application of host B 420. The message may be conveyed to a wireless modem chipset 413 associated with host A 410. The wireless modem chipset 413 may be an IEEE 802.11ax chipset as depicted in FIG. 4. The wireless modem chipset 413 may generate signals for k spatial layers corresponding to at least a part of the message. The signals for k spatial layers may be sent to the IF/RF converter module 415 associated with host A 410. The IF/RF converter module 415 may generate combined signals by converting the k spatial layers into k orthogonal channel bands. The combined signals may be sent to the 60 GHz RFIC 417 associated with host A. The 60 GHz RFIC 417 may transmit the combined signals wirelessly using an array of antennas associated with the 60 GHz RFIC 417. The 60 GHz RFIC 427 associated with host B 420 may receive the signals from the 60 GHz RFIC 417 associated with host A 410. The received signals may comprise k orthogonal channel bands. The received signals may be sent to the IF/RF converter module 425 associated with host B 420. The IF/RF converter module 425 may convert the received RF signals into IF signals by converting signals from each of the k orthogonal channel bands into each of k spatial layers. The IF/RF converter module 425 module may send the converted IF signals to the wireless modem, an IEEE 802.11ax chipset 423 associated with host B 420. The wireless modem may decode data corresponding to the at least a part of the message from the k spatial layers. The decoded data may be delivered to the application of host B 420. Although this disclosure describes transmitting data from a first wireless communication device to a second wireless communication device over an WLAN in 60 GHz frequency bands by reusing commercially available chipsets in a particular manner, this disclosure contemplates transmitting data from a first wireless communication device to a second wireless communication device over an WLAN in 60 GHz frequency bands by reusing commercially available chipsets in any suitable manner.

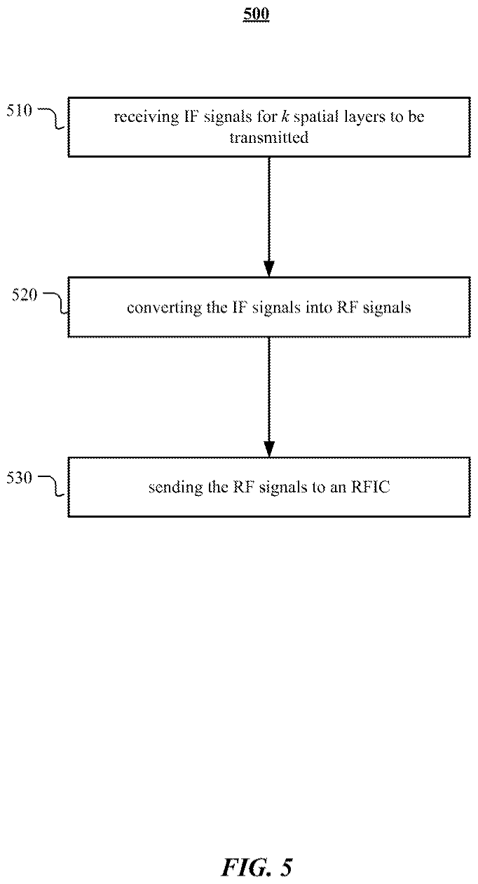

FIG. 5 illustrates an example method 500 for converting IF signals to RF signals for transmitting signals over a WLAN in 60 GHz frequency bands by reusing commercially available chipsets. The method may begin at step 510, where a module of a wireless communication device may receive IF signals for k spatial layers to be transmitted , from a wireless modem associated with the wireless communication device. Each of the k spatial layers may occupy a pre-determined bandwidth. k may be two or more. At step 520, the module may convert the IF signals into RF signals by converting each of the k spatial layers into each of k orthogonal channel bands. Neighboring two channel bands among the k orthogonal channel bands may be separated by a pre-determined frequency separation that is large enough to avoid interference between the two channel bands. At step 530, the module may send the RF signals to an RFIC associated with the wireless communication device. The RFIC may transmit the RF signals wirelessly. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for converting IF to RF for transmitting signals over a WLAN in 60 GHz frequency bands by reusing commercially available chipsets including the particular steps of the method of FIG. 5, this disclosure contemplates any suitable method for converting IF to RF for transmitting signals over a WLAN in 60 GHz frequency bands by reusing commercially available chipsets including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

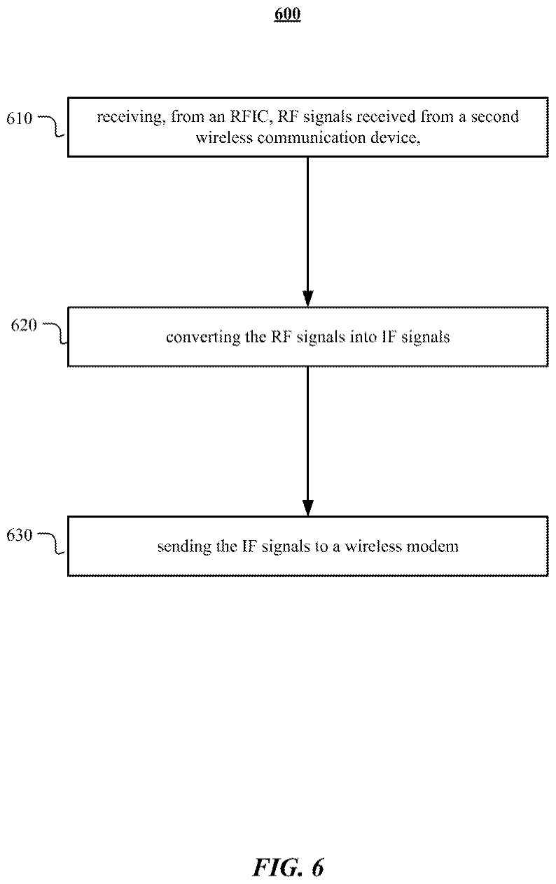

FIG. 6 illustrates an example method $00 for converting RF signals to IF signals for receiving signals over a WLAN in 60 GHz frequency bands by reusing commercially available chipsets. The method may begin at step 610, where a module associated with a first wireless communication device may the computing device may receive RF signals received from a second wireless communication device from an RFIC associated with the first wireless communication device. The RF signals may comprise k orthogonal channel bands. k may be two or more. At step 620, the module may convert the RF signals into IF signals by converting signals from each of the k orthogonal channel bands into each of k spatial layers. At step 630, the module may send the IF signals to a wireless modem associated with the first wireless communication device. The wireless modem may decode the data from each of the k spatial layers. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for converting RF signals to IF signals for receiving signals over a WLAN in 60 GHz frequency bands by reusing commercially available chipsets including the particular steps of the method of FIG. 6, this disclosure contemplates any suitable method for converting RF signals to IF signals for receiving signals over a WLAN in 60 GHz frequency bands by reusing commercially available chipsets including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

### Systems and Methods

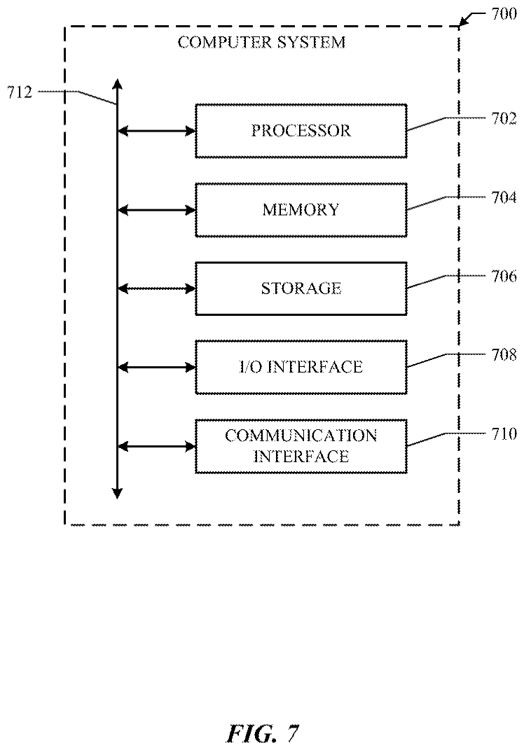

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a module of a wireless communication device:
receiving, from a wireless modem associated with the wireless communication device, intermediate frequency (IF) signals for k spatial layers to be transmitted, wherein each of the k spatial layers occupies a pre-determined bandwidth, and wherein k is two or more;
converting the IF signals into radio frequency (RF) signals by converting each of the k spatial layers into each of k orthogonal channel bands, wherein neighboring two channel bands among the k orthogonal channel bands are separated by a pre-determined frequency separation that is large enough to avoid interference between the two channel bands; and
sending the RF signals to a radio-frequency integrated circuit (RFIC) associated with the wireless communication device, wherein the RFIC transmits the RF signals wirelessly.

2. The method of claim 1, wherein the wireless modem is a baseband modem.

3. The method of claim 2, wherein the IF signals are analog in-phase and quadrature (I/Q) signals.

4. The method of claim 1, wherein the wireless modem is a system on a chip (SoC) comprising a baseband module and an RF module.

5. The method of claim 4, wherein the IF signals are generated by the RF module within the wireless modem.

6. The method of claim 1, wherein the RFIC is a 60 GHz RFIC, and wherein the RF signals are 60 GHz signals.

7. The method of claim 1, wherein the module is a part of the wireless modem.

8. The method of claim 1, wherein the module is a part of the RFIC.

9. The method of claim 1, wherein the module is on a printed circuit board (PCB).

10. The method of claim 1, wherein the wireless modem sends control parameters to the RFIC through a control interface.

11. The method of claim 10, wherein the control interface is provided with general-purpose input/output (GPIO) pins.

12. The method of claim 10, wherein the control parameters comprise a transmit and receive beam index, a transmit power, or a receive gain index.

13. A method comprising, by a module of a first wireless communication device:
receiving, from an RFIC associated with the first wireless communication device, RF signals received from a second wireless communication device, wherein the RF signals comprise k orthogonal channel bands, and wherein k is two or more;
converting the RF signals into IF signals by converting signals from each of the k orthogonal channel bands into each of k spatial layers; and
sending the IF signals to a wireless modem associated with the first wireless communication device, wherein the wireless modem decodes the data from each of the k spatial layers.

14. One or more computer-readable non-transitory storage media embodying software that is operable when executed to, by a module of a wireless communication device:
receive, from a wireless modem associated with the wireless communication device, intermediate frequency (IF) signals for k spatial layers to be transmitted, wherein each of the k spatial layers occupies a pre-determined bandwidth, and wherein k is two or more;
convert the IF signals into radio frequency (RF) signals by converting each of the k spatial layers into each of k orthogonal channel bands, wherein neighboring two channel bands among the k orthogonal channel bands are separated by a pre-determined frequency separation that is large enough to avoid interference between the two channel bands; and
send the RF signals to a radio-frequency integrated circuit (RFIC) associated with the wireless communication device, wherein the RFIC transmits the RF signals wirelessly.

15. The media of claim 14, wherein the wireless modem is a baseband modem.

16. The media of claim 15, wherein the IF signals are analog in-phase and quadrature (UQ) signals.

17. The media of claim 14, wherein the wireless modem is a system on a chip (SoC) comprising a baseband module and an RF module.

18. The media of claim 17, wherein the IF signals are generated by the RF module within the wireless modem.

19. The media of claim 14, wherein the RFIC is a 60 GHz RFIC, and wherein the RF signals are 60 GHz signals.

20. The media of claim 14, wherein the module is a part of the wireless modem.
